(19) United States
(12) Patent Application Publication
(10) Pub. No.: US 2014/0218490 A1
(43) Pub. Date: Aug. 7, 2014

(54) Receiver-Side Adjustment of Stereoscopic Images

(71) Applicants: Andrey Norkin, Solna (SE); Ivana Girdzijauskas, Solna (SE)

(72) Inventors: Andrey Norkin, Solna (SE); Ivana Girdzijauskas, Solna (SE)

(73) Assignee: Telefonaktiebolaget L M Ericsson (pulb), Stockholm (SE)

(21) Appl. No.: 14/241,607

(22) PCT Filed: Nov. 11, 2011
(86) PCT No.: PCT/EP2011/069942

§ 371 Date: Feb. 27, 2014

Related U.S. Application Data
(60) Provisional application No. 61/528,912, filed on Aug. 30, 2011.

(51) Int. Cl. H04N 13/00; H04N 13/04

(52) U.S. Cl. CPC H04N 13/0022; H04N 13/0447; H04N 13/0402; H04N 13/04; H04N 13/0007
USPC 348/51

(57) ABSTRACT

There is provided a video apparatus having a stereoscopic display associated therewith, the video apparatus arranged to: receive at least one image and at least one reference parameter associated with said image; calculate a baseline distance for synthesizing a view, the calculation based upon the received at least one reference parameter and at least one parameter of the stereoscopic display; synthesize at least one view using the baseline distance and the received at least one image; and send the received at least one image and the synthesized at least one image to the stereoscopic display for display.

### TECHNICAL FIELD

The present application relates to a video apparatus, a communication system, a method in a video apparatus and a computer readable medium.

### BACKGROUND

Three dimensional (3D) video including three dimensional television (3DTV) is becoming increasingly important in consumer electronics, mobile devices, computers and the movie theatres. Different technologies for displaying 3D video have existed for many years. A requirement of such technologies is to deliver a different perspective view to each eye of a viewer, or user of the device.

One of the first solutions for adding the depth dimension to video was the stereoscopic video. In stereoscopic video, the left and the right eyes of the viewer are shown slightly different pictures. This was done by using an anaglyph, shutter or polarized glasses that filter a display and show different images to the left and the right eyes of the viewer, and in this way creating a perception of depth. In this case, the perceived depth of the point in the image is determined by its relative displacement between the left view and the right view.

A new generation of auto-stereoscopic displays allows the viewer to experience depth perception without glasses. These displays project slightly different pictures in different directions, a principle displayed in FIG. 1. Therefore, if the viewer is located in an appropriate viewing position in front of the display, his left and right eye see slightly different pictures of the same scene, which makes it possible to create the perception of depth. In order to achieve smooth parallax and change of the viewpoint when the user moves his head in front of the screen, a number of views (typically 7-28) are generated.

In FIG. 1 eight views are shown, each repeated at three different viewing angles. The shaded areas are viewing regions where the 3D effect will not work, either because one eye will not receive a view (at the two extremes of viewing angle) or because the two eyes of a viewer receive views that do not correspond to create a 3D effect (as will happen at the sections where the repeated view sequences meet).

The use of auto-stereoscopic screens for 3DTV creates a problem in the transmission of the 3DTV signals. Using between 7 and 28 views in a display means that all of these views must be transmitted to the device. This can require a very high bit rate, or at least a bit rate much higher than is required for the transmission of a similar 2DTV channel.

This problem could be addressed by transmitting a low number of key views (e.g. 1 to 3) and generating the other views by a view synthesis process, starting from the transmitted key views. These synthesized views can be located between the key views (interpolated) or outside the range covered by key views (extrapolated).

In stereoscopic video, the left and the right views may be coded independently or jointly. Another way to obtain one view from the other view is by using the view synthesis. One view synthesis technique is that of depth image based rendering (DIBR). In order to facilitate the view synthesis, DIBR uses at least one depth map of the key view or views. A depth map can be represented by a grey-scale image having the same resolution as the view (video frame). Then, each pixel of the depth map represents the distance from the camera to the object for the corresponding pixel in the 2D image/video frame.

In order to facilitate DIBR view synthesis at a receiver, a number of parameters are required and must therefore be signaled to the receiver in conjunction with the 2D image and the depth map. Among those parameters are “z near” and “m z far”, these represent the closest and the farthest depth values in the depth maps for the image under consideration. These values are needed in order to map the quantized depth map samples to the real depth values that they represent. Another set of parameters that is needed for the view synthesis are camera parameters.

Camera parameters for the 3D video are usually split into two parts. The first part are the intrinsic (internal) camera parameters represents the optical characteristics of the camera for the image taken, such as the focal length, the coordinates of the images principal point and the radial distortion. The second part is the extrinsic (external) camera parameters, represent the camera position and the direction of its optical axis in the chosen real world coordinates (the important aspect here is the position of the camera relative to each other and the objects in the scene). Both internal and external camera parameters are required in the view synthesis process based on usage of the depth information (such as DIBR).

An alternative solution to sending the key cameras is the layered depth video (LDV) that uses multiple layers for scene representation. These layers may comprise: foreground texture, foreground depth, background texture and background depth.

One of advantages of view synthesis is that it is possible to generate additional views from the transmitted view or views (these may be used with a stereoscopic or a multiview display). These additional views can be generated at particular virtual viewing positions that are sometimes called virtual cameras. These virtual cameras are points in the 3D space with the parameters (extrinsic and intrinsic) similar to those of the transmitted cameras but located in different spatial positions. In the following, this document addresses the case of a one dimensional (1D) linear camera arrangement with the cameras pointing at directions parallel to each other and parallel to the z axis. Camera centers have the same z and y coordinates, with only the x coordinate changing from camera to camera. This is a common camera setup for stereoscopic and “3D multiview” video. The so-called “toed-in” camera setup can be converted to the 1D linear camera setup by a rectification process.

The distance between two cameras in stereo/3D setup is usually called the baseline (or the baseline distance). In a stereo camera setup, the baseline is usually approximately equal to the distance between the human eyes (normally about 6 centimeters). However, the baseline distance can vary depending on the scene and other factors, such as the type or style of 3D effect it is desired to achieve.

In the following, the distance between the cameras for the left and the right views is expressed in the units of the external (extrinsic) camera coordinates. In case of the stereo screen, the baseline is the distance between the virtual (or real) cameras used to obtain the views for the stereo-pair. In case of a multi-view screen, the baseline is the distance between two cameras (or virtual cameras) that the left and the right eyes of a viewer see when watching the video on an auto-stereoscopic display at an appropriate viewing position. It should be noted, that in the case of an auto-stereoscopic display, the views seen by the left and the right eyes of the viewer are not always the angularly consecutive views. However, this kind of information is known to the display manufacturer and can be used in the view synthesis process. It should also be noted that in such an example the distance between the two closest generated views is not necessarily the baseline distance. (It is possible that an additional view will be projected to the space between the viewer's eyes.)

One of the advantages of synthesizing one (or more) view(s) is the improved coding efficiency comparing to sending all the views. Another important advantage of the view synthesis is that views can be generated at any particular positions of virtual camera, thus making it possible to change or adjust the depth perception of the viewer and adjust the depth perception to the screen size.

The subjective depth perception of the point on the screen in stereo and 3D systems depends on the apparent displacement of the point between the left and right pictures, on the viewing distance, and on the distance between the observer's eyes. However, the parallax in physical units of measurement (e.g. centimeters) depends also on the screen size. Therefore, simply changing the physical screen size (when showing the same 3D video sequence) and therefore the parallax, or even the viewing distance from the screen and therefore would change the depth perception. From this it follows that changing from one physical screen size to the other or rendering images for an inappropriate viewing distance may change the physical relationship between the spatial size and the depth of the stereo-picture, thus making the stereo-picture look unnatural.

### SUMMARY

Using 3D displays having different physical characteristics such as screen size may require adjusting the view synthesis parameters at the receiver side. According to the method disclosed herein, there is provided a way to signal optimal view-synthesis parameters for a large variety of screen sizes since the size of the screen on which the sequences will be shown is usually either not known or varies throughout the set of receiving devices.

This is done by determining an optimal baseline for the chosen screen size by using formulas derived herein. This baseline distance is determined based on the reference baseline and reference screen size that are signaled to the receiver. The method also describes: a syntax for signaling the reference baseline and the reference screen size to the receiver; and a syntax for signaling several sets of such parameters for a large span of possible screen sizes. In the latter case, each set of parameters covers a set of the corresponding screen sizes.

Accordingly, there is provided a video apparatus having a stereoscopic display associated therewith, the video apparatus arranged to: receive at least one image and at least one reference parameter associated with said image; calculate a baseline distance for synthesizing a view, the calculation based upon the received at least one reference parameter and at least one parameter of the stereoscopic display; synthesize at least one view using the baseline distance and the received at least one image; and send the received at least one image and the synthesized at least one image to the stereoscopic display for display.

The video apparatus may be further arranged to calculate at least one further parameter for synthesizing a view, and the video apparatus further arranged to synthesize the at least one view using the baseline distance, the at least one further parameter and the received at least one image. The at least one further parameter may comprise an intrinsic or extrinsic camera parameter. The at least one further parameter may comprise at least one of the sensor shift, the camera focal distance and the camera's z-coordinate.

There is further provided a method, in a video apparatus having a stereoscopic display associated therewith, the method comprising: receiving at least one image and at least one reference parameter associated with said image; calculating a baseline distance for synthesizing a view, the calculation based upon the received at least one reference parameter and at least one parameter of the stereoscopic display; synthesizing at least one view using the baseline distance and the received at least one image; and sending the received at least one image and the synthesized at least one image to the stereoscopic display for display.

There is further provided a computer-readable medium, carrying instructions, which, when executed by computer logic, causes said computer logic to carry out any of the methods described herein.

### BRIEF DESCRIPTION OF THE DRAWINGS

A method and apparatus for receiver-side adjustment of stereoscopic images will now be described, by way of example only, with reference to the accompanying drawings, in which:

FIG. 1 illustrates a multi-view display scheme;

FIG. 2 shows the geometry of a pair of eyes looking at a distant point displayed on a screen;

FIG. 3, shows a first screen with width W₁, and a second screen with width W₂.

FIG. 4 shows the relationship between the perceived depth, the screen parallax, viewing distance and the distance between the human eyes for the first and second screens of FIG. 3, overlaid;

FIG. 5 shows the dependency between the change of camera baseline distance and change of disparity;

FIGS. 6a and 6b illustrate the scaling of both viewing distance and screen width each by a respective scaling factor;

FIG. 7 illustrates a method disclosed herein; and

FIG. 8 illustrates an apparatus for performing the above described method.

### DETAILED DESCRIPTION

Technical standards have been developed to define ways of sending camera parameters to the decoder, the camera parameters relating to an associated view which is transmitted to the decoder. One of these standards is the multi-view video coding (MVC) standard, which is defined in the annex H of the advanced video coding (AVC) standard, also known as H.264 [published as: Information technology—Coding of audio-visual objects—Part 10: Advanced Video Coding, ISO/IEC FDIS 14496-10:201 X(E), 6th edition, 2010]. The scope of MVC covers joint coding of stereo or multiple views representing the scene from several viewpoints. The process exploits the correlation between views of the same scene in order to achieve better compression efficiency compared to compressing the views independently. The MVC standard also covers sending the camera parameters information to the decoder. The camera parameters are sent as supplementary enhancement information (SEI) message. The syntax of this SEI message is shown in Table 1.

For clarification of the meaning of the syntax elements listed in Table 1, the reader is directed to the advanced video coding standard (referred to above), incorporated herein by reference. Further information can be found at “Revised syntax for SEI message on multiview acquisition information”, by S. Yea, A. Vetro, A. Smolic, and H. Brust, Joint Video Team (JVT) of ISO/IEC MPEG & ITU-T VCEG, JVT-Z038r1, Antalya, January 2008, both of which are also incorporated herein by reference.

TABLE 1
Multiview acquisition information SEI message syntax

| multiview_acquisition_info( payloadSize ) { | C | Descriptor |
|---|---|---|
| num_views_minus1 | | ue(v) |
| intrinsic_param_flag | 5 | u(1) |
| extrinsic_param_flag | 5 | u(1) |
| if ( instrinsic_param_flag ) { | | |
| intrinsic_params_equal | 5 | u(1) |
| prec_focal_length | 5 | ue(v) |
| prec_principal_point | 5 | ue(v) |
| prec_skew_factor | 5 | ue(v) |
| if( intrinsic_params_equal ) | | |
| num_of_param_sets = 1 | | |
| else | | |
| num_of_param_sets = num_views_minus1 + 1 | | |
| for( i = 0; i < num_of_param_sets; i++ ) { | | |
| sign_focal_length_x[ i ] | 5 | u(1) |
| exponent_focal_length_x[ i ] | 5 | u(6) |
| mantissa_focal_length_x[ i ] | 5 | u(v) |
| sign_focal_length_y[ i ] | 5 | u(1) |
| exponent_focal_length_y[ i ] | 5 | u(6) |
| mantissa_focal_length_y[ i ] | 5 | u(v) |
| sign_principal_point_x[ i ] | 5 | u(1) |
| exponent_principal_point_x[ i ] | 5 | u(6) |
| mantissa_principal_point_x[ i ] | 5 | u(v) |
| sign_principal_point_y[ i ] | 5 | u(1) |
| exponent_principal_point_y[ i ] | 5 | u(6) |
| mantissa_principal_point_y[ i ] | 5 | u(v) |
| sign_skew_factor[ i ] | 5 | u(1) |
| exponent_skew_factor[ i ] | 5 | u(6) |
| mantissa_skew_factor[ i ] | 5 | u(v) |
| } | | |
| } | | |
| if( extrinsic_param_flag ) { | | |
| prec_rotation_param | 5 | ue(v) |
| prec_translation_param | 5 | ue(v) |
| for( i = 0; i <= num_views_minus1; i++) { | | |
| for ( j = 1; j <= 3; j++) { /* row */ | | |
| for ( k = 1; k <= 3; k++) { /* column */ | | |
| sign_r[ i ][ j ][ k ] | 5 | u(1) |
| exponent_r[ i ][ j ][ k ] | 5 | u(6) |
| mantissa_r[ i ][ j ][ k ] | 5 | u(v) |
| } | | |
| sign_t[ i ][ j ] | 5 | u(1) |
| exponent_t[ i ][ j ] | 5 | u(6) |
| mantissa_t[ i ][ j ] | 5 | u(v) |
| }}}} | | |

The camera parameters from Table 1 are sent in floating point representation. The floating point representation provides support for a higher dynamic range of the parameters and facilitates sending the camera parameters with higher precision.

As explained above, different screen sizes require use of different view-synthesis parameters when rendering the stereoscopic or 3D video for a screen of a particular size. One easy way to demonstrate a problem with different screen sizes is to consider creating the effect of infinity on the stereo/3D screen. In order to produce a point perceived at infinity on a 3D screen, the displacement of the point at the screen (the parallax), should be equal to distance between the human eyes.

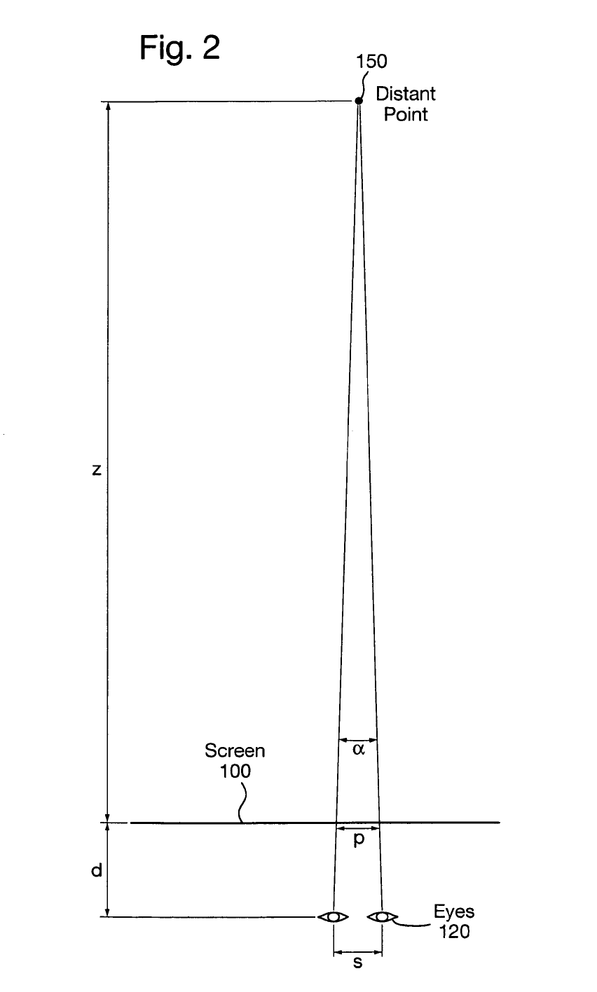

This is apparent from FIG. 2 which shows a pair of eyes 120 looking at a distant point 150 displayed on a screen 100. The distant point 150 has a depth value of z and a parallax separation on the screen 100 of p. As z tends to infinity, the value of p will approach the distance s between the eyes 120. Conversely, in order to create an effect that a point is located at the distance of the screen, the point should be placed without displacement (zero parallax, p=0) in the left and the right views on the screen. The points located between the screen distance and the infinity should be located between those two distances. Similar observations can be applied to the points perceived as located in front of the screen.

In order to create an impression that a point is located at infinity, the parallax between the left and the right view should be equal to the distance between the human eyes. This applies no matter what the screen size is. For points located at the screen distance, the parallax should be zero. However, if the same stereo pair of views is shown using displays having screens of different sizes, the observed parallax (the displacement of the point between the left and the right view) is different. Therefore, adjustment of view synthesis parameters is needed when displaying the video at screens of different sizes if it is desirable to keep the proportions of the objects in a 3D scene (namely, to keep constant the ratio of the depth z to the spatial dimensions x and y).

It is possible for the value of p to be negative, such that the right eye sees an image point on the screen displayed to the left of the corresponding image point displayed to the left eye. This gives the perception of the image point being displayed in front of the screen.

There is provided herein a method and apparatus for determining a proper baseline distance for the screen of particular size, which may be used by a receiver to appropriately render a 3D scene. In some embodiments, the method and apparatus may further comprise determining other parameters as well as the baseline distance. Such parameters may include sensor shift, or camera focal distance.

Suppose that it is required to scale screen width (VV) with a scaling factor b. Assume that the viewing distance (d) then also changes with the same scaling factor b. This is reasonable given that the optimal viewing distance of a display is usually determined as a multiple of some dimension of the physical display (e.g. 3 times the screen height in case of an HD resolution display). In its turn, the perceived depth relative to the screen size must be adjusted relative to the screen width (size) in order to avoid changing the ratio between the spatial and the depth dimension in the scene.

This arrangement is illustrated in FIG. 3, showing a first screen 301 with width W1, and a second screen 302 with width W2. The original parameters associated with screen 301 are W1 (screen width), z/(perceived depth), d1 (viewing distance). The scaled parameters associated with the second screen 302 are W2 (new screen width), z2 (new perceived depth), d2 (new viewing distance). As the height of the screen and the screen diagonal have a constant ratio to the screen width for the same display format, they can be used in the equations interchangeably with the screen width. The separation of the viewer's eyes (s) remains the same from the first screen 301 to the second screen 302.

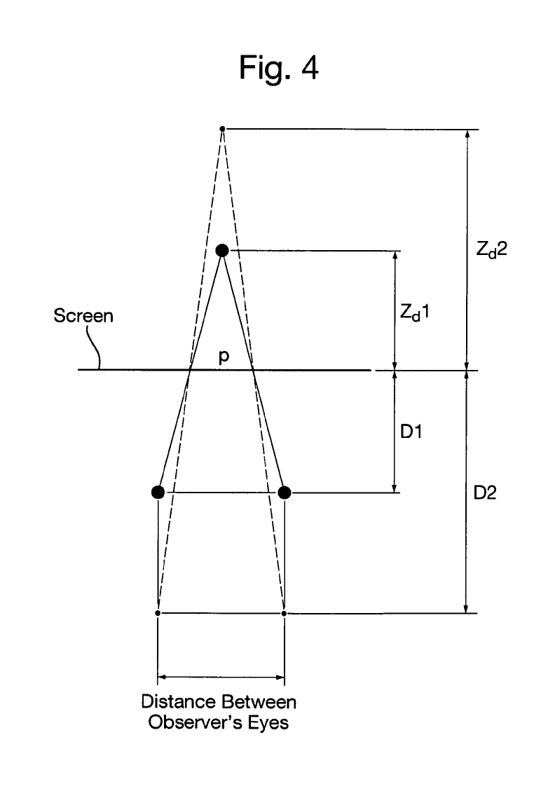

FIG. 4 shows the relationship between the perceived depth, the screen parallax, viewing distance and the distance between the human eyes for the first screen 301 and the second screen 302 overlaid. The distance between the eyes does not change with the scaling. FIG. 4 shows that changing the viewing distance by a scaling factor causes the perceived depth of a point to change by the same scaling factor if the physical screen parallax does not change. However, when changing the screen size by a scaling factor, the parallax distance at the screen would change by the same scaling factor which would generate too much depth in the perceived point.

It follows that a scaling factor of the screen parallax in units of pixels is required that is the reciprocal of the scaling factor of the screen width. (The screen parallax in units of pixels is equivalent to the disparity.)

It can be shown from the camera setup that disparity d (equal to parallax p in units of pixels) can be found according to the following formula:

d=tc*F*(1/z_{conv}−1/z),

where F is the focal distance, z_{conv} is the z coordinate of the convergence point (plane) and z is the depth coordinate. Under assumption that the depth from the camera and the convergence plane are constant, the parallax (in unit of pixels) is proportional to the baseline distance.

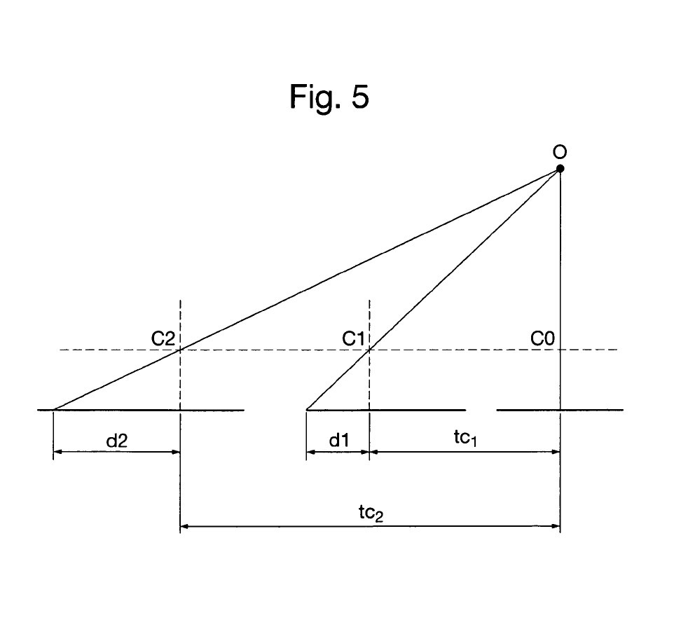

A similar observation can be made from FIG. 5, which shows the dependency between the change of camera baseline distance and change of disparity. C0, C1, and C2 are virtual camera positions. tc1 and tc2 are baseline distances for virtual camera C1 and virtual camera C2 respectively. d1 and d2 are disparity values for point O as seen from camera C1 and camera C2 respectively (both relative to camera C0). When changing the baseline distance from tc1 to tc2, the disparity related to the point O changes from p1 to p2 with the ratio p1/p2 equal to the ratio tc1/tc2.

Returning to the requirement that the screen parallax must scale with a reciprocal to the screen width scaling, it follows that the baseline distance should be adjusted with the reciprocal of the coefficient with which the screen width was scaled in order to keep the same perceived proportions of the objects in the 3D scene. Typically the viewing distance is scaled by the same factor as, the screen width though this is not always the case.

This document therefore proposes sending a reference screen width (W_{d ref}) to the receiver. A reference baseline (tC_{ref}) may be predetermined, derived from camera parameters, may be sent to the receiver. The reference baseline may be assumed equal to some value for both the sent image and the video data. After that the receiver adjusts the baseline (tc) for the chosen screen width (W_{d}) according to the following formula:

tc=tc_{ref}*W_{d ref}/W_{d} (Equation 1)

Under the assumption that the ratio between the screen width and screen height are kept constant for all the screen sizes, the reference screen width and the actual screen width can be changed to the reference screen diagonal and the actual screen diagonal. Alternatively, the screen height and the reference screen height can be used. In the following, the screen diagonal and the screen height size can be used interchangeably with the screen width. When talking about the screen height and the screen diagonal, the actual height and the diagonal of the image (video) shown on the screen is meant, rather than the size of the size of the physical screen including areas that are not used for displaying the transmitted 3D picture (or video).

### Choosing Camera Parameters for a Viewing Distance and a Screen Width

When deriving Equation 1, an assumption was made that the viewing distance is changed by the same proportion as the change of the screen width (or height). Sometimes this assumption may not be valid since different stereo/3D screen technologies may require different viewing distance from the screen and also due to other conditions at the end-user side. For example a high definition television may be viewed at a distance of three times the display height, whereas smart phone screen is likely to be viewed at a considerably higher multiple of the display height. Another example is two smart phones with different screen size that are viewed from approximately the same distance.

It can be shown that if the perceived depth is scaled by a different factor than the screen width, then the relative perceived depth of the objects can be maintained by scaling both the baseline distance and the camera distance at the same time.

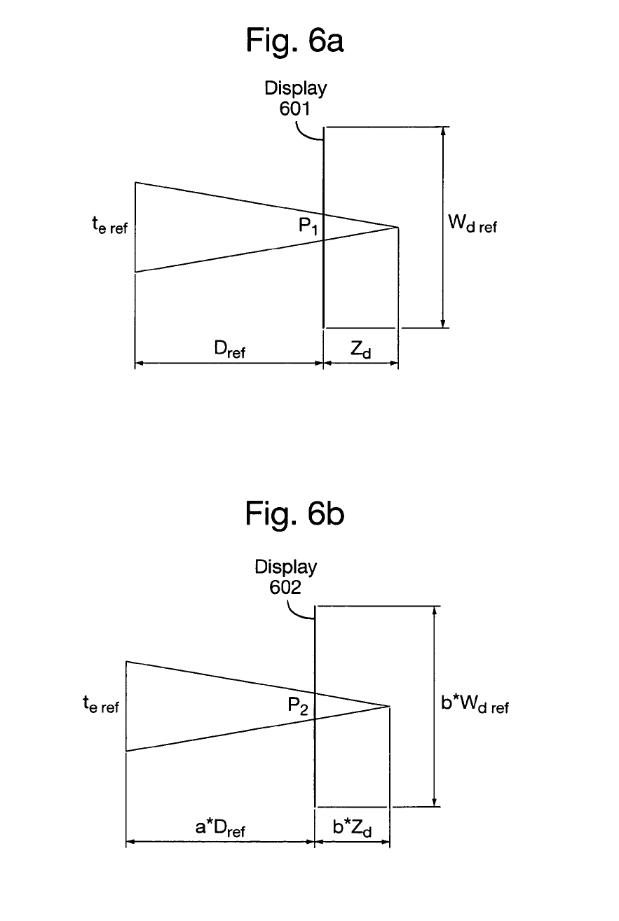

Let a denote the scaling factor for the viewing distance and b the scaling factor for the screen width. This scaling is shown in FIGS. 6a and 6b. FIG. 6a shows a display 601 having width W d ref, and FIG. 6b shows a display 602 having a width b×W_{d ref}.

In this case, it can be shown (see Appendix A for the formula derivation) that the ratio of the horizontal size of a particular object to its perceived depth can be kept constant if the following scaling factors are applied: factor c for the convergence distance (Z_{conv}) and factor g for the baseline distance tc. Here, when changing the convergence distance, it is meant that the virtual cameras are moving closer to or further from the scene while the “convergence plane” of the cameras stays at the same position as before, Therefore, the objects located at the convergence plane will still be perceived as being at the display distance. Also, the scaling factor c should be applied to the focal distance (F), that is F=c*F_{ref}. Scaling of the focal distance F is required to keep the size of the objects at the convergence distance the same. The above has been shown to apply to horizontal scale, the same holds true for vertical scale. Equation 2 (as derived in Appendix A) is as follows:

$$\begin{matrix}c = \frac{1}{1 - \frac{{W}_{Dref} {t}_{cref} {F}_{ref}}{a {W}_{sref} {t}_{eref} {Z}_{conv 1 ref}} ( a - b )} \\ = \frac{1}{1 - \frac{{W}_{Dref} {h}_{ref}}{{W}_{sref} {t}_{eref}} ( 1 - \frac{b}{a} )} \\ = \frac{1}{1 - {S}_{Mref} \frac{{h}_{ref}}{{t}_{eref}} ( 1 - \frac{b}{a} )}\end{matrix} \qquad ( Equation 2 )$$

g=c/a

where, tc_{ref} is the reference baseline distance, W_{D ref} is the reference display width, W_{s ref} is the sensor width, h_{ref} is the reference sensor shift, t_{e ref} is the reference distance between the observer's eyes, and F_{ref} is the cameras' focal distance in the reference setup. In this equation a=D/D_{ref}, and b=W_{d}/W_{d ref}.

The shift of the z coordinate for the camera coordinates is calculated as:

Z_{shift}=Z₂−Z₁=(c−1)Z_{conv ref}=(c−1)t_{cref}F_{ref}/h_{ref}

The new baseline should then be scaled as:

tc=tc_{ref}*C,

and a new sensor shift h should be set as

$$h = \frac{{t}_{ c} F}{{Z}_{conv}} = \frac{c}{a} {h}_{ref} = g {h}_{ref}$$

Equation 1 is thus a special case of Equation 2, the special case being when the scaling factor for the viewing distance is equal to the scaling factor for the screen width (a=b).

In order to use Equation 2 for adaptation of both the viewing distance and the screen width, one of the parameters that are sent to the decoder must be used. Possible such parameters are sensor shift h and sensor width Wₛ (in pixels). These may be obtained from the extrinsic and intrinsic camera parameters since they are signaled, for example, in the SEI message of MVC specification.

However, at least one of the following parameters must also be signaled additionally in order to use the Equation 2: reference display width W_{d ref}, the reference viewing distance D_{ref}. One of these may be derived from the other where an optimal ratio of viewing distance to display size may be determined. Alternatively, both parameters are signaled.

The reference distance between the observer's eyes could additionally be signaled to the decoder, since the viewer's eye separation distance is also included in equation 2. However, the reference distance for the observer eyes may also be set instead to a constant value (e.g. 6 cm). In that case, this value does not need to be signaled but may instead be agreed upon by the transmitter and receiver, or even made standard.

The perceived depth may be adapted for a person with eye separation different to the standard (for example, a child). To adjust camera parameters to another observer's eyes separation, the baseline must be scaled by the same scaling factor as between the actual and the reference eye separation followed by the sensor shift h adjustment in order to keep the convergence plane at the same position as before.

When only two stereo views are sent to the decoder, one sending the reference baseline distance (tc_{ref}) in the explicit form may be omitted because it may be assumed instead that the reference baseline is the actual baseline for the transmitted views (that can be derived from the signaled camera parameters, or in some other way). In this case, according to the relation between the actual screen width and the reference screen width, the reference baseline may be modified with a scale factor that is the reciprocal of the scaling factor from the reference screen width to the actual screen width.

Since the range of possible screen sizes may be very different (ranging from mobile phone screen size to the cinema screen size), one relation between the reference screen size and the reference baseline distance might not cover all the possible range of screen sizes. Therefore, as an extension to the method it is proposed to send also the largest and the smallest screen size in addition to the reference screen size and the reference baseline. In this way, the signaled reference parameters are applicable for calculation of the baseline distance for the screen sizes in the range between the smallest and the largest screen sizes. For the screen sizes outside the range of the possible screen sizes, other reference parameters should be used. A set of reference screen sizes with the corresponding baselines may be sent to the receiver. Each set of the reference baseline and the corresponding reference screen size includes the largest and the smallest screen sizes for which Equation 1 may be used to derive the baseline from the reference baseline signaled for the particular range of screen sizes. The intervals between the smallest and the largest actual screen sizes for different reference screen sizes may overlap.

Finding the most appropriate baseline for the size of the display associated with the receiver may also be used in the scenarios other than the view synthesis. For example, views with proper baseline may be chosen from the views transmitted to the receiver or the views with the proper baseline may be chosen for downloading or streaming.

Also, in some scenarios as, for example, in case of the real-time capturing and transmission of stereoscopic/3D video, the camera baseline (and other capture parameters) may be adjusted in order to match the display size and/or viewing distance at the receiving end.

Some reference parameters (a reference baseline) may be determined at the transmitter side from the camera setup or/and algorithmically, from the obtained views (sequences). Other reference parameters, e.g. the reference screen size and the reference viewing distance, may be determined before or after obtaining the 3D/stereo video material by using the geometrical relations between the camera capture parameters and the parameters of stereoscopic display or may be found subjectively by studying the subjective viewing experience when watching the obtained 3D/stereoscopic video.

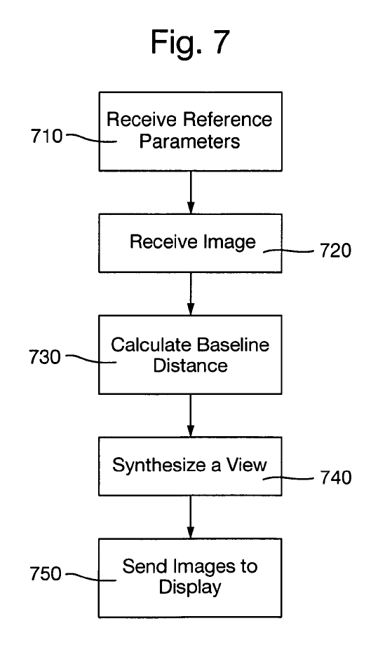

FIG. 7 illustrates a method disclosed herein. The method may be performed in a video apparatus having a stereoscopic display associated therewith. The stereoscopic display is arranged to display images it receives from the video apparatus. At 710, the video apparatus receives a reference parameter associated with a signal representing a 3D scene. At 720, an image is received as part of the 3D scene. At 730, the receiver calculates a baseline distance for synthesizing a view. The calculation is based upon the received at least one reference parameter associated with the signal and at least one parameter of the stereoscopic display. At 740, the receiver synthesizes at least one view using the baseline distance and the received at least one image. At 750 the receiver sends the received at least one image and the synthesized at least one image to the stereoscopic display for display.

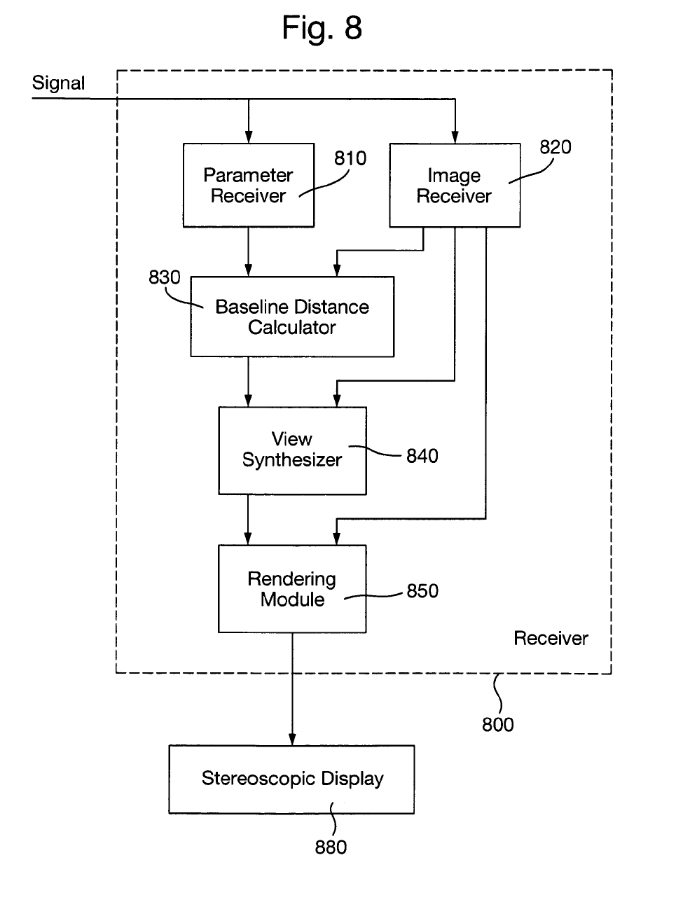

FIG. 8 illustrates an apparatus for performing the above described method. The apparatus comprises a receiver 800 and a stereoscopic display 880. The receiver 800 comprises a parameter receiver 810, an image receiver 820, a baseline distance calculator 830, a view synthesizer 840, and a rendering module 850.

The receiver 800 receives a signal, which is processed by both the parameter receiver 810 and the image receiver 820. The parameter receiver 810 derives a reference parameter from the signal. The image receiver 820 derives an image from the signal. The baseline distance calculator 830 receives the parameter from the parameter receiver 810 and the image from the image receiver 820. The baseline distance calculator 830 calculates a baseline distance. The baseline distance is sent to the view synthesizer 840 and is used to synthesize at least one view. The synthesized view and the received image are sent to the rendering module 850 for passing to the stereoscopic display 880 for display.

In an alternative embodiment, at 830 the baseline distance is calculated and also at least one additional parameter is calculated. Both the calculated baseline distance and the calculated additional parameter are used by the view synthesizer 840. The additional parameter may be at least one of sensor shift and camera focal distance.

The following embodiments give different examples of how the above described method may be employed.

### Embodiment 1

This embodiment sends a reference baseline and a reference screen (display) width parameters using the floating point representation (in the same format that is used in sending camera parameters in the multiview_acquisition_info message in MVC).

| ref_width_baseline_info( payloadSize ) { | C | Descriptor |
|---|---|---|
| prec_baseline_ref | 5 | ue(v) |
| prec_scr_width_ref | 5 | ue(v) |
| exponent_baseline_ref | 5 | u(6) |
| mantissa_baseline_ref | 5 | u(v) |
| exponent_scr_width_ref | 5 | u(6) |
| mantissa_scr_width_ref | 5 | u(v) |
| } | | |

The baseline for the display size at the receiver is calculated based on the following formula

b=b_{ref}*W_{ref}/W

The units of the W_{ref} may be the same as units of the baseline. It is, however, more practical to send the value of W_{ref} in the units of centimeters or inches. The only thing which should be fixed in relation to the W_{ref} signaling is that the W (actual width) is measured in the same units as W_{ref}.

### Embodiment 2

This embodiment addresses a situation when several values of a reference display (screen) width and the viewing distances each for a different class of display sizes are signaled in one SEI message. That would ensure better adaptation of the baseline size to the particular screen size (for the class of screen sizes).

This embodiment signals also the smallest and the largest screen sizes for each class of screen sizes that may be used for deriving the baseline from the presented formula.

| multi_ref_width_baseline_info ( payloadSize ) { | C | Descriptor |
|---|---|---|
| prec_baseline_ref | 5 | ue(v) |
| prec_scr_width_ref | 5 | ue(v) |
| prec_viewing_dist_ref* | 5 | ue(v) |
| prec_eyes_dist_ref* | 5 | ue(v) |
| exponent_eyes_dist_ref* | 5 | u(6) |
| mantissa_{—} eyes_dist_ref* | 5 | u(v) |
| num_ref_baselines_minus1 | 5 | ue(v) |
| for( i = 0; i < num_ref_baselines_minus1; i++ ) { | | |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| exponent_viewing_dist_ref[i]* | 5 | u(6) |
| mantissa_{—} viewing_dist_ref[i]* | 5 | u(v) |
| exponent_smallest_scr_width[i] | 5 | u(6) |
| mantissa_smallest_scr_width[i] | 5 | u(v) |
| exponent_largest_scr_width[i] | 5 | u(6) |
| mantissa_largest_scr_width[i] | 5 | u(v) |
| } | | |

*Fields marked with “*” are signaled if Equation 2 is to be used when the viewing distance is not changing proportionally to the screen width or adjusting the rendering for a particular eyes distance is desired.

### Embodiment 3

This embodiment sends a reference screen (display) width parameters using the floating point representation (in the same format that is used in sending camera parameters in the multiview_acquisition_info message in MVC). The reference baseline is, however, sent implicitly by sending the view_ids that correspond to the respective cameras that constitute the reference pair). The baseline is then being found as the distance between the centers of these cameras.

| ref_width_info( payloadSize ) { | C | Descriptor |
|---|---|---|
| ref_view_num1 | 5 | ue(v) |
| ref_view_num2 | 5 | ue(v) |
| prec_viewing_dist_ref | 5 | ue(v) |
| prec_scr_width_ref | 5 | ue(v) |
| exponent_scr_width_ref | 5 | u(6) |
| mantissa_scr_width_ref | 5 | u(v) |
| exponent_viewing_dist_ref | 5 | u(6) |
| mantissa_viewing_dist ref | 5 | u(v) |
| } | | |

For example, in case of 1D camera arrangement, the reference baseline distance can be found as the difference between the x component of the translation parameter vector corresponding to two cameras, which view numbers (ref_view_num2 and ref_view_num2) have been signaled.

The baseline for the display size at the receiver is calculated based on the following formula

tc=tc_{ref}*W_{d ref}/W_{d}

The units of the W_{d ref} may be the same as units of the baseline. It is, however, may be more practical to send the value of W_{d ref} in the units of centimeters or inches. The only thing which should be fixed in relation to the W_{d ref} signaling is that the W_{d} (actual width) is measured in the same units as W_{d ref}.

This embodiment may also be combined with any other embodiment presented in this invention, in a way that the reference baseline distance is not signaled but rather derived from camera parameters of the cameras (or the views). These view numbers may be sent explicitly (as in this embodiment) or be assumed if only two views have been sent to the receiver. In the case where the camera parameters are not sent to the receiver, a certain value for the baseline distance may be assumed as corresponding to the pair of views indicated by view_num and this assumed value may then be used in calculations.

### Embodiment 4

This embodiment sends the baseline as the floating point representation and the reference width parameter as the unsigned integer representation.

| ref_width_baseline_info( payloadSize ) { | C | Descriptor |
|---|---|---|
| prec_baseline_ref | 5 | ue(v) |
| exponent_baseline_ref | 5 | u(6) |
| mantissa_baseline_ref | 5 | u(v) |
| scr_width_ref | 5 | u(16) |
| } | | |

The baseline for the reference image is calculated based on the following formula.

tc=tc_{ref}*W_{d ref}/W_{d}

### Embodiment 5

In this embodiment the baseline is sent in the floating point representation and the diagonal size of the reference screen is sent in the unsigned int representation.

| ref_diag_baseline_info( payloadSize ) { | C | Descriptor |
|---|---|---|
| prec_baseline_ref | 5 | ue(v) |
| exponent_baseline_ref | 5 | u(6) |
| mantissa_baseline_ref | 5 | u(v) |
| scr_diag_ref | 5 | u(16) |
| } | | |

The baseline for a stereo pair is calculated based on the following formula

tc=tC_{ref}*diag_{ref}/diag

The unit of measurement of the scr_diag_ref may be the same as units of the baseline. However it may be more practical to send the scr_diag_ref in units of centimeters or inches. One thing which should be fixed in relation to the scr_diag_ref signaling is that the actual screen diagonal size (diag) is measured in the same units as scr_diag_ref.

### Embodiment 6

Signaling of the reference baseline may be also included in the multiview_aquisition_info message.

| multiview_acquisition_info( payloadSize ) { | C | Descriptor |
|---|---|---|
| num_views_minus1 | | ue(v) |
| intrinsic_param_flag | 5 | u(1) |
| extrinsic_param_flag | 5 | u(1) |
| reference_scr_width_flag | 5 | u(1) |
| if ( instrinsic_param_flag ) { | | |
| intrinsic_params_equal | 5 | u(1) |
| prec_focal_length | 5 | ue(v) |
| prec_principal_point | 5 | ue(v) |
| prec_skew_factor | 5 | ue(v) |
| if( intrinsic_params_equal ) | | |
| num_of_param_sets = 1 | | |
| else | | |
| num_of_param_sets = num_views_minus1 + 1 | | |
| for( i = 0; i < num_of_param_sets; i++) { | | |
| sign_focal_length_x[ i ] | 5 | u(1) |
| exponent_focal_length_x[ i ] | 5 | u(6) |
| mantissa_focal_length_x[ i ] | 5 | u(v) |
| sign_focal_length_y[ i ] | 5 | u(1) |
| exponent_focal_length_y[ i ] | 5 | u(6) |
| mantissa_focal_length_y[ i ] | 5 | u(v) |
| sign_principal_point_x[ i ] | 5 | u(1) |
| exponent_principal_point_x[ i ] | 5 | u(6) |
| mantissa_principal_point_x[ i ] | 5 | u(v) |
| sign_principal_point_y[ i ] | 5 | u(1) |
| exponent_principal_point_y[ i ] | 5 | u(6) |
| mantissa_principal_point_y[ i ] | 5 | u(v) |
| sign_skew_factor[ i ] | 5 | u(1) |
| exponent_skew_factor[ i ] | 5 | u(6) |
| mantissa_skew_factor[ i ] | 5 | u(v) |
| } | | |
| } | | |
| if( extrinsic_param_flag ) { | | |
| prec_rotation_param | 5 | ue(v) |
| prec_translation_param | 5 | ue(v) |
| for( i = 0; i <= num_views_minus1; i++) { | | |
| for ( j = 1; j <= 3; j++) { /* row */ | | |
| for ( k = 1; k <= 3; k++) { /* column */ | | |
| sign_r[ i ][ j ][ k ] | 5 | u(1) |
| exponent_r[ i ][ j ][ k ] | 5 | u(6) |
| mantissa_r[ i ][ j ][ k ] | 5 | u(v) |
| } | | |
| sign_t[ i ][ j ] | 5 | u(1) |
| exponent_t[ i ][ j ] | 5 | u(6) |
| mantissa_t[ i ][ j ] | 5 | u(v) |
| } | | |
| } | | |
| } | | |
| } | | |
| if( reference_scr_width_flag) { | | |
| prec_scr_width_ref | 5 | ue(v) |
| exponent_scr_width_ref | 5 | u(6) |
| mantissa_scr_width_ref | 5 | u(v) |
| prec_scr_width_ref | 5 | ue(v) |
| exponent_scr_width_ref | 5 | u(6) |
| mantissa_scr_width_ref | 5 | u(v) |
| prec_baseline_ref | 5 | ue(v) |
| exponent_baseline _ref | 5 | u(6) |
| mantissa_basline ref | 5 | u(v) |
| } | | |
| } | | |

### Embodiment 7

This embodiment also signals the smallest and the largest screen sizes that may use Equation 1 to derive the baseline from the signaled reference baseline and reference screen width.

| ref_baseline_width_info( payloadSize ) { | C | Descriptor |
|---|---|---|
| prec_baseline_ref | 5 | ue(v) |
| prec_scr_width_ref | 5 | ue(v) |
| exponent_baseline_ref | 5 | u(6) |
| mantissa_baseline_ref | 5 | u(v) |
| exponent_scr_width_ref | 5 | u(6) |
| mantissa_scr_width_ref | 5 | u(v) |
| exponent_smallest_scr_width | 5 | u(6) |
| mantissa_smallest_scr_width | 5 | u(v) |
| exponent_largest_scr_width | 5 | u(6) |
| mantissa_largest_scr_width | 5 | u(v) |
| } | | |

### Embodiment 8

This embodiment addresses a situation when several values of a reference display (screen) width and the viewing distances each for a different class of display sizes are signaled in one SEI message. That would ensure better adaptation of the baseline size to the particular screen size (for the class of screen sizes).

This embodiment signals also the smallest and the largest screen sizes for each class of screen sizes that may be used for deriving the baseline from the presented formula.

| multi_ref_width_baseline_info ( payloadSize ) { | C | Descriptor |
|---|---|---|
| prec_baseline_ref | 5 | ue(v) |
| prec_scr_width_ref | 5 | ue(v) |
| prec_viewing_dist_ref | 5 | ue(v) |
| prec_eyes_dist_ref* | 5 | ue(v) |
| exponent_eyes_dist_ref* | 5 | u(6) |
| mantissa_{—} eyes_dist_ref* | 5 | u(v) |
| num_ref_baselines_minus1 | 5 | ue(v) |
| for( i = 0; i < num_ref_baselines_minus1; i++) { | | |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| exponent_viewing_dist_ref[i] | 5 | u(6) |
| mantissa_{—} viewing_dist_ref[i] | 5 | u(v) |
| exponent_smallest_scr_width[i] | 5 | u(6) |
| mantissa_smallest_scr_width[i] | 5 | u(v) |
| exponent_largest_scr_width[i] | 5 | u(6) |
| mantissa_largest_scr_width[i] | 5 | u(v) |
| exponent_smallest_viewing_dist[i] | 5 | u(6) |
| mantissa_{—} smallest_viewing_dist[i] | 5 | u(v) |
| exponent_largest_viewing_dist[i] | 5 | u(6) |
| mantissa_largest_viewing_dist[i] | 5 | u(v) |
| } | | |
| } | | |

*Fields marked with “*” should be signaled if Equation 2 is supposed to be used or adjusting the rendering for a particular eyes distance is desired.

The smallest and the largest viewing distances are also sent for every screen size.

### Embodiment 9

In this embodiment the encoder does not send the smallest and the largest screen widths but only sends a number of reference screen widths with the respective baselines. The receiver may choose the reference screen width that is closer (the closest) to the actual screen width.

The screen diagonal may be used instead of the screen width, like in the other embodiments.

| multi_ref_width_baseline_info ( payloadSize ) { | C | Descriptor |
|---|---|---|
| prec_baseline_ref | 5 | ue(v) |
| prec_scr_width_ref | 5 | ue(v) |
| num_ref_baselines_minus1 | | ue(v) |
| for( i = 0; i < num_ref_baselines_minus1; i++) { | | |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| } | | |
| } | | |

### Embodiment 10

If the stereo/3D video content is encoded by using a scalable extension of a video codec, it is possible to signal what resolution should be applied to what screen size by using a dependency_id corresponding to a particular resolution.

| multi_ref_width_baseline_info ( payloadSize ) { | C | Descriptor |
|---|---|---|
| prec_baseline_ref | 5 | ue(v) |
| prec_scr_width_ref | 5 | ue(v) |
| prec_viewing_dist_ref | 5 | ue(v) |
| prec_eyes_dist_ref* | 5 | ue(v) |
| exponent_eyes_dist_ref* | 5 | u(6) |
| mantissa_{—} eyes_dist_ref* | 5 | u(v) |
| num_ref_baseline_minus1 | | ue(v) |
| for( i = 0; i < num_ref_baseline_minus1; i++) { | | |
| dependency_id[i] | 5 | u(3) |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| exponent_viewing_dist_ref[i] | 5 | u(6) |
| mantissa_{—} viewing_dist_ref[i] | 5 | u(v) |
| exponent_smallest_scr_width[i] | 5 | u(6) |
| mantissa_smallest_scr_width[i] | 5 | u(v) |
| exponent_largest_scr_width[i] | 5 | u(6) |
| mantissa_largest_scr_width[i] | 5 | u(v) |
| } | | |
| } | | |

### Embodiment 11

This embodiment sends a reference baseline and a reference viewing distance parameters using the floating point representation (in the same format that is used when sending camera parameters in the multiview_acquisition_info message in MVC).

| ref_width_dist_baseline_eyes,info( payloadSize ) { | C | Descriptor |
|---|---|---|
| prec_baseline_ref | 5 | ue(v) |
| prec_scr_width_ref | 5 | ue(v) |
| prec_viewing_dist_ref | 5 | ue(v) |
| prec_eyes_dist_ref | 5 | ue(v) |
| exponent_baseline_ref | 5 | u(6) |
| mantissa_baseline_ref | 5 | u(v) |
| exponent_scr_width_ref | 5 | u(6) |
| mantissa_scr_width_ref | 5 | u(v) |
| exponent_viewing_dist_ref | 5 | u(6) |
| mantissa_viewing_dist_ref | 5 | u(v) |
| exponent_eyes_dist_ref | 5 | u(6) |
| mantissa_eyes_dist _ref | 5 | u(v) |
| } | | |

Units of viewing distance D_{ref} and screen width W_{d ref} may be the same as units of the baseline. However, it may be more practical to send the value of D_{ref} and W_{d ref} in the units of centimeters or inches. The only thing which should be fixed in relation to the D_{ref} and W_{d ref} signaling is that the D (actual viewing distance) is measured in the same units as D_{ref} and the observer's eyes distance to is measured in the same units.

Equation 2 is used then to adjust the camera parameters.

### Embodiment 12

This embodiment sends a reference baseline and a reference viewing distance parameters using the floating point representation (in the same format that is used when sending camera parameters in the multiview_acquisition_info message in MVC).

| ref_width_dist_baseline_info( payloadSize ) { | C | Descriptor |
|---|---|---|
| ref_view_num1 | 5 | ue(v) |
| ref_view_num2 | 5 | ue(v) |
| prec_scr_width_ref | 5 | ue(v) |
| prec_viewing_dist_ref | 5 | ue(v) |
| prec_eyes_dist_ref | 5 | ue(v) |
| exponent_scr_width_ref | 5 | u(6) |
| mantissa_scr_width_ref | 5 | u(v) |
| exponent_viewing_dist_ref | 5 | u(6) |
| mantissa_viewing_dist_ref | 5 | u(v) |
| exponent_eyes_dist_ref | 5 | u(6) |
| mantissa_eyes_dist _ref | 5 | u(v) |
| } | | |

For example, in case of 1D camera arrangement, the reference baseline distance may be found as the difference between the x component of the translation parameter vector corresponding to two cameras, which view numbers (ref_view_num2 and ref_view_num2) have been signaled.

Units of viewing distance D_{ref} and screen width W_{d ref} may be the same as units of the baseline. It may be practical to send the values of D_{ref} and W_{d ref} ref in the units of centimeters or inches. The only thing which should be fixed in relation to D_{ref} signaling is that the D (actual viewing distance) is measured in the same units as D_{ref} and the eyes distance.

Equation 2 is used then to adjust the camera parameters.

### Embodiment 13

In this embodiment the encoder (transmitted) sends a number of reference screen widths with the respective viewing distances and reference baselines. The receiver may choose the reference screen width (or viewing distance) that is closer (the closest) to the actual screen width (or/and viewing distance).

The screen diagonal may be used instead of the screen width, like in the other embodiments in case Equation 1 is used. If Equation 2 is used, the screen width should be sent. Otherwise, if the screen diagonal is used and sent in Equation 2, the sensor diagonal should be used instead of sensor width Ws in Equation 2.

| multi_ref_width_dist_baseline_info ( payloadSize ) { | C | Descriptor |
|---|---|---|
| prec_baseline_ref | 5 | ue(v) |
| prec_scr_width_ref | 5 | ue(v) |
| prec_viewing_dist_ref | 5 | ue(v) |
| num_ref_baselines_minus1 | | ue(v) |
| for( i = 0; i < num_ref_baselines_minus1; i++ ) { | | |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| exponent_viewing_dist_ref[i] | 5 | u(6) |
| mantissa_viewing_dist_ref[i] | 5 | u(v) |
| } | | |
| } | | |

### Embodiment 14

In this embodiment the encoder (transmitter) sends a number of reference screen widths with the respective viewing distances and reference baselines. The receiver may choose the reference screen width (or viewing distance) that is closer (the closest) to the actual screen width (or/and viewing distance). The reference observer's eyes distance is also sent.

The screen diagonal may be used instead of the screen width, like in the other embodiments in case Equation 1 is used. If Equation 2 is used, the screen width should be sent. Otherwise, if the screen diagonal is used and sent in Equation 2, the sensor diagonal should be used instead of sensor width Ws in Equation 2.

| eyes_multi_ref_width_dist_baseline_info | | |
|---|---|---|
| ( payloadSize ) { | C | Descriptor |
| prec_baseline_ref | 5 | ue(v) |
| prec_scr_width_ref | 5 | ue(v) |
| prec_viewing_dist_ref | 5 | ue(v) |
| prec_eyes_dist_ref | 5 | ue(v) |
| exponent_{—} eyes_dist_ref | 5 | u(6) |
| mantissa_{—} eyes_dist_ref | 5 | u(v) |
| num_ref_baselines_minus1 | | ue(v) |
| for( i = 0; i < num_ref_baselines_minus1; i++ ) { | | |
| exponent_baseline_ref[i] | 5 | u(6) |
| mantissa_baseline_ref[i] | 5 | u(v) |
| exponent_scr_width_ref[i] | 5 | u(6) |
| mantissa_scr_width_ref[i] | 5 | u(v) |
| exponent_viewing_dist_ref[i] | 5 | u(6) |
| mantissa_viewing_dist_ref[i] | 5 | u(v) |
| } | | |
| } | | |

### Embodiment 15

This embodiment sends a reference baseline, a reference screen (display) width, and a reference ratio between the viewing distance and the screen widths using the floating point representation.

| ref_width_dist_ratio_baseline_info( payloadSize ) { | C | Descriptor |
|---|---|---|
| prec_baseline_ref | 5 | ue(v) |
| prec_scr_width_ref | 5 | ue(v) |
| prec_ratio_dist_width_ref | 5 | ue(v) |
| exponent_baseline_ref | 5 | u(6) |
| mantissa_baseline_ref | 5 | u(v) |
| exponent_scr_width_ref | 5 | u(6) |
| mantissa_scr_width_ref | 5 | u(v) |
| exponent_ratio_dist_width_ref | 5 | u(6) |
| mantissa_ratio_dist_width_ref | 5 | u(v) |
| } | | |

Equation 4 may be used in order to adjust the baseline for the particular screen width/viewing distance.

### Embodiment 16

This embodiment sends a reference baseline and a reference screen (display) width parameters using the floating point representation (in the same format that is used in sending camera parameters in the multiview_acquisition_info message in MVC).

| ref_width_baseline_info( payloadSize ) { | C | Descriptor |
|---|---|---|
| prec_scr_width_ref | 5 | ue(v) |
| exponent_scr_width_ref | 5 | u(6) |
| mantissa_scr_width_ref | 5 | u(v) |
| } | | |

In this case, the baseline distance is assumed for the video/image data sent to the receiver. The baseline (relative to the assumed reference baseline) for the display size at the receiver is calculated based on the following formula.

b=b_{ref}*W_{ref}/W

The units of the W_{ref} may be the same as units of the baseline. It is, however, more practical to send the value of W_{ref} in the units of centimeters or inches. The variable W (actual width) is measured in the same units as W_{ref}.

### Embodiment 17

This embodiment sends a reference screen (display) width parameters using the floating point representation (in the same format that is used in sending camera parameters in the multiview_acquisition_info message in MVC). The reference baseline is, however, not sent but instead assumed, being the baseline for image/video stereo pair.

| ref_width_info( payloadSize ) { | C | Descriptor |
|---|---|---|
| prec_viewing_dist_ref | 5 | ue(v) |
| prec_scr_width_ref | 5 | ue(v) |
| exponent_scr_width_ref | 5 | u(6) |
| mantissa_scr_width_ref | 5 | u(v) |
| exponent_viewing_dist_ref | 5 | u(6) |
| mantissa_viewing_dist ref | 5 | u(v) |
| } | | |

The baseline for the display size at the receiver is calculated based on the following formula

tc=tc_{ref}*W_{d ref} Wd

The units of the W_{d ref} may be expressed in the same units as of the baseline. However, it may be more practical to send the value of W_{d ref} in the units of centimeters or inches. The variable W (actual width) is measured in the same units as those in which W_{ref} is signaled with.

This embodiment may also be combined with any other embodiment presented in this document, in so far as the reference baseline distance may be not signaled but rather assumed.

The above described methods and apparatus enable the determination of the optimal baseline for synthesizing a view or views from a 3D video signal or for choosing camera views with a proper baseline to use as a stereo-pair in order to keep the proper aspect ratio between the spatial (2D) distances in the scene displayed on the screen and the perceived depth. The baseline distance is derived from the at least one reference parameter sent to the receiver.

The above described methods and apparatus allow the determination of a proper baseline distance for a large variety of screen sizes without signaling the baseline distance for each screen size separately. Since only the reference screen parameters are transmitted to the receiver, the bandwidth is used more efficiently (because there are bit-rate savings). Moreover, it is possible to derive a proper baseline distance even for a screen size that was not considered at the transmitter side.

The syntax for sending the information enabling a choice of a proper baseline at the receiver side is proposed together with the corresponding syntax elements. Examples of the corresponding SEI messages are given. The method may be applied for both the stereo and multi-view 3D screens and for a large variety of ways to transmit the 3D/stereoscopic video.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular communications standards, these examples are not intended to be the limit of the communications standards to which the disclosed method and apparatus may be applied. For example, while specific examples have been given in the context of MVC and SEI messages, the principles disclosed herein may also be applied to any video compression and transmission system, and indeed any system which transmits multiple views for display on a device capable of displaying 3D images.

### Annex A

### Derivation of Equation 2

### Keeping Proportions of the Objects (the Task Formulation)

In order to maintain the same (or similar) viewing experience of the users using displays of different size and watching them from different distances, it is important to keep the perceived depth of the objects proportional to their horizontal and vertical screens sizes. Than means that if the screen width is scaled with factor b, the perceived depth should be scaled with the same factor b in order to maintain the same width/depth relation of the object in the video scene. These proportions should be maintained at any viewing distance (the distance between the screen and the viewer).

So, the task can be formulated as in the following (see FIG. 6a for a reference setup and FIG. 6b for a target setup). Having the reference distance from the display D₁ scaled with the factor a, i.e. the new value D₂=a D₁, and the reference display width W_{d 1} scaled with the factor b, i.e. W_{d 2}=b W_{d 1}, the perceived depth of the objects relative to the screen size should be scaled with the same factor (b), that is Z_{d 2}=b Z_{d 1}. This would allow keeping the same relations between the width of the objects and their depth as in the original (reference) video.

The question which we investigate is how the view rendering parameters should be changed in order for the above mentioned equations to hold.

### Formula Derivation

Since we would like to keep the same ratio between the screen width and the perceived depth relative to the display position, the following equality should hold.

$$\frac{{Z}_{d 2}}{{W}_{d 2}} = \frac{{Z}_{d 1}}{{W}_{d 1}}$$

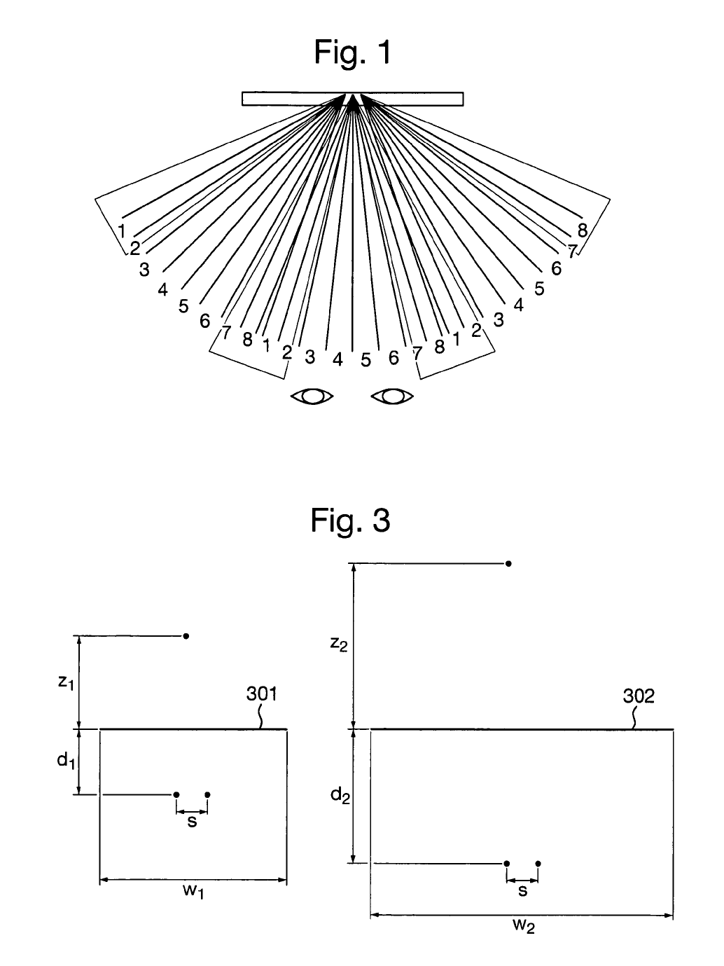

One can see from FIG. 1 that parallax P₁ that would result in the depth relative to the display Z_{d} can at the reference screen be found as

$${P}_{1} = \frac{{t}_{e} {Z}_{d 1}}{{D}_{1} + {Z}_{d 1}}$$

while parallax P₂ that would result in the be found as

$${P}_{2} = \frac{{t}_{e} b {Z}_{d 1}}{a {D}_{1} + b {Z}_{d 1}} .$$

The relative parallax P_{rel 1} (normalized for the screen width W_{d}) is found as

$${P}_{rel 1} = \frac{{t}_{e} {Z}_{d 1}}{{W}_{d 1} ( {D}_{1} + {Z}_{d 1} )}$$

while parallax P₂ that would result in the be found as

$${P}_{rel 2} = \frac{{t}_{e} {Z}_{d 1}}{{W}_{d 1} ( a {D}_{1} + b {Z}_{d 1} )}$$

From the last two formulas, when taking Z_{d} out of the equations, the following equality should hold (in order for N value to scale accordingly).

$$\frac{a}{{P}_{rel 1}} - \frac{1}{{P}_{rel 2}} = \frac{{W}_{d 1}}{{t}_{e}} ( a - b ) \qquad ( 3 )$$

One should notice here that the relative value of parallax is equal to the relative disparity corresponding to the same point in the camera space.

The disparity value can be found from the camera parameters and received depth information as

$$d = {t}_{c} F ( \frac{1}{{Z}_{conv}} - \frac{1}{Z} ) ,$$

where t_{c} is a baseline distance, Z_{conv} is a convergence distance, F is a focal distance, d is disparity and Z is the depth of the object from the camera.

When changing the Z_{conv}, we should also change the focal distance F of the camera in order to avoid scaling of the objects size. We would like the images of the objects located at the convergence distance to have the same size relative to the sensor width and to the screen size when displays (in other words to keep the same “virtual screen” in the camera space). This requires changing focal length with the same scaling factor as the convergence distance, i.e. F₂=c F₁.

From here, one can find the relative disparities for the reference camera and the second camera setup as.

$$\begin{matrix}{d}_{rel 1} = \frac{{t}_{c 1} {F}_{1}}{{W}_{s}} ( \frac{1}{{Z}_{conv 1}} - \frac{1}{{Z}_{1}} ) & ( 4 ) \\ {d}_{rel 2} = \frac{{t}_{c 2} c {F}_{1}}{{W}_{s}} ( \frac{1}{{Z}_{conv 2}} - \frac{1}{{Z}_{2}} ) . & ( 5 )\end{matrix}$$

In order to accommodate for changes of the screen width and the viewing distance, we allow changing the baseline distance and virtual cameras shift over the z coordinate. Changing the z coordinate of the cameras would therefore change the Z_{conv} and Z. In order to account for these changes, lets set Z_{conv 2}=c Z_{conv1} and the baseline distance t_{c2}=g t_{c1}. Lets also denote depth relative to the convergence plane as Zᵣ=Z₁−Z_{conv1}. From this it follows that

Z₂=c Z_{conv1}+Zᵣ.

When substituting the above expressions into Eq.4 and Eq.5, the following expressions for relative disparities are obtained.

$$\begin{matrix}{d}_{rel 1} = \frac{{t}_{c 1} {F}_{1}}{{W}_{s}} ( \frac{1}{{Z}_{conv 1}} - \frac{1}{{Z}_{conv 1} + {Z}_{r}} ) & ( 6 ) \\ {d}_{rel 2} = \frac{g {t}_{c 1} c {F}_{1}}{{W}_{s}} ( \frac{1}{c {Z}_{conv 1}} - \frac{1}{c {Z}_{conv 1} + {Z}_{r}} ) & ( 7 )\end{matrix}$$

By taking into account that Pᵣₑₗ=dᵣₑₗ and substituting Eq.6 and Eq.6 into Eq. 3, the following expression is obtained.

$$( a - \frac{c}{d} ) {Z}_{conv 1}^{2} + ( a - \frac{1}{d} ) {Z}_{conv 1} {Z}_{r} = {Z}_{r} \frac{{W}_{d 1} {t}_{c 1} {F}_{1}}{{t}_{e} {W}_{S}} ( a - b ) \qquad ( 8 )$$

In order for equality (8) to hold for all relative depth values Zᵣ, which can take any values in the range (Zₙₑₐᵣ, Z_{far}), it is necessary that

$$\{ \begin{matrix}( a - \frac{c}{d} ) {z}_{conv 1}^{2} = 0 \\ ( a - \frac{1}{d} ) {z}_{conv 1} = \frac{{W}_{d 1} {t}_{c 1} {F}_{1}}{{t}_{e} {W}_{S}} ( a - b )\end{matrix}$$

Solving the system of equations, one gets that the following scaling factors c and g should be used for Z_{conv} and t_{c} respectively.

$$\begin{matrix}c = \frac{1}{1 - \frac{{W}_{d 1} {t}_{c 1} {F}_{1}}{a {W}_{s} {t}_{e} {Z}_{conv 1}} ( a - b )} \\ = \frac{1}{1 - \frac{{W}_{d 1} {h}_{1}}{{W}_{s} {t}_{e}} ( 1 - \frac{b}{a} )} \\ = \frac{1}{1 - {S}_{M} \frac{{h}_{1}}{{t}_{e}} ( 1 - \frac{b}{a} )}\end{matrix}$$

$$g = c / a ,$$

where h is a sensor shift and S_{M}=W_{D}/W_{S} is the so-called magnification factor (from sensor width to the screen width).

From the obtained scaling parameter, the shift of virtual cameras' z-coordinate is obtained as Z_{shift}=Z₂−Z₁=(c−1)Z_{conv1}=(c−1)t_{c1}F₁/h₁

The sensor shift is then set to the value h₂

$${h}_{2} = \frac{{t}_{ c 2} {F}_{2}}{{Z}_{conv 2}} = \frac{c}{a} {h}_{1} = g {h}_{1}$$

### Special Case

One important special case is when the viewing distance and the screen size are changed with the same factor, that is a=b.

If a=b, then

c=1, g=11a, h₂=h₁/a, F₂=F₁

This means that the cameras should stay at the same distance from the scene (virtual screen) and all Z values should stay the same. The baseline will change with the factor inversely proportional to the screen scaling, and the same with sensor shift. One can see from here that Equation 1 is a special case of Equation 2.

1. A video apparatus having a stereoscopic display associated therewith, the video apparatus arranged to:
receive at least one image and at least one reference parameter associated with said image;
calculate a baseline distance for synthesizing a view, the calculation based upon the received at least one reference parameter and at least one parameter of the stereoscopic display;
synthesize at least one view using the baseline distance and the received at least one image; and
send the received at least one image and the synthesized at least one view to the stereoscopic display for display.

2. The video apparatus of claim 1, wherein the baseline distance is the distance between two camera positions.

3. The video apparatus of claim 1, wherein the baseline distance is given in the units of the external camera coordinates.

4. The video apparatus of claim 1, wherein the stereoscopic display is a multi-view display, and wherein the baseline distance is the distance between two camera positions, the two camera positions corresponding to the views for each eye of a user at a viewing position.

5. The video apparatus claim 1, the video apparatus further arranged to calculate at least one further parameter for synthesizing a view, and the video apparatus further arranged to synthesize the at least one view using the baseline distance, the at least one further parameter and the received at least one image.

6. The video apparatus of claim 5, wherein the at least one further parameter comprises an intrinsic camera parameter.

7. The video apparatus of claim 1, wherein the at least one reference parameter comprises at least one of: reference baseline distance; reference screen width; reference distance between the viewer's eyes; and reference viewing distance.

8. The video apparatus of claim 1, wherein the at least one parameter of the stereoscopic display comprises at least one of: baseline distance; screen width; reference distance between the viewer's eyes; and viewing distance.

9. The video apparatus of claim 1, wherein the calculation of baseline distance is further based upon maximum and minimum range values received with the at least one image.

10. The video apparatus of claim 1, wherein the stereoscopic display is an autostereoscopic display.

11. The video apparatus of claim 1, wherein the at least one image comprises a frame of a video sequence.

12. The video apparatus of claim 1, wherein the video apparatus comprises a component of at least one of: a television receiver; a television; a set-top-box; a stereoscopic display; an autostereoscopic display; a video-conferencing system; a graphics processor for a device; a wireless communications device; and a media player (such as a Blu-ray™ disk player).

13. A method, in a video apparatus having a stereoscopic display associated therewith, the method comprising:
the video apparatus receiving at least one image and at least one reference parameter associated with said image;
the video apparatus calculating a baseline distance for synthesizing a view, the calculation based upon the received at least one reference parameter and at least one parameter of the stereoscopic display;
the video apparatus synthesizing at least one view using the baseline distance and the received at least one image; and
the video apparatus sending the received at least one image and the synthesized at least one image to the stereoscopic display for display.

14. The method of claim 13, wherein the baseline distance is the distance between two camera positions.

15. The method of claim 13, wherein the baseline distance is given in the units of the external camera coordinates.

16. The method of claim 13, wherein the stereoscopic display is a multi-view display, and wherein the baseline distance is the distance between two camera positions, the two camera positions corresponding to the views for each eye of a user at a viewing position.

17. The method of claim 13, the method further comprising calculating at least one further parameter for synthesizing a view, and synthesizing the at least one view using the baseline distance, the at least one further parameter and the received at least one image.

18. The method of claim 17, wherein the at least one further parameter comprises an intrinsic camera parameter.

19. The method of claim 13, wherein the at least one reference parameter comprises at least one of reference baseline distance; reference screen width; reference distance between the viewer's eyes; and reference viewing distance.

20. The method of claim 13, wherein the at least one parameter of the stereoscopic display comprises at least one of: baseline distance; screen width; reference distance between the viewer's eyes; and viewing distance.

21. The method of claim 13, wherein the calculation of baseline distance is further based upon maximum and minimum range values received with the at least one image.

22. The method of claim 13, wherein the stereoscopic display is an autostereoscopic display.

23. The method of claim 13, wherein the at least one image comprises a frame of a video sequence.

24. The method of claim 13, wherein the video apparatus comprises a component of at least one of: a set-top-box; a television; a stereoscopic display; and an autostereoscopic display.

25. A non-transitory computer-readable medium storing instructions that, when executed by computer logic, causes said computer logic to carry out the method of claim 1.
